(19) United States
(12) Patent Application Publication
(10) Pub. No.: US 2006/0063588 A1
(43) Pub. Date: Mar. 23, 2006

(54) Wagering machine with a bonus game

(76) Inventor: James J. Poole, Buckinghamshire (GB)

Correspondence Address: Daniel J. Burnham;JENKENS & GILCHRIST, A PROFESSIONAL CORPORATION, 225 W. Washington, Ste. 2600, Chicago, IL, 60606-3418, US

(21) Appl. No.: 11/225,996

(22) Filed: Sep. 14, 2005

Related U.S. Application Data
(60) Provisional application No. 60/610,854, filed on Sep. 17, 2004.

(51) Int. Cl. A63F 13/00

(52) U.S. Cl. 463/25; 463/20

(57) ABSTRACT

A gaming terminal and method of playing a wagering game. The terminal includes a first display and a second display having a plurality of bonus areas. The terminal further includes a wagering game having a plurality of symbols that indicate a randomly selected outcome of the wagering game. In response to the randomly selected outcome being a bonus outcome, the wagering game displays a bonus symbol in the second display for awarding a bonus symbol under a specified condition.

### CROSS-REFERENCE TO RELATED APPLICATIONS

The present application claims priority to U.S. Provisional Patent Application Ser. No. 60/610,854, entitled “Wagering Machine With A Bonus Game” filed on Sep. 17, 2004, which is incorporated herein by reference in its entirety.

### FIELD OF THE INVENTION

The present invention relates generally to gaming terminals, and more particularly, to a gaming terminal having a bonus award.

### BACKGROUND OF THE INVENTION

Gaming machines, such as slot machines, video poker machines, and the like, have been a cornerstone of the gaming industry for several years. Generally, the popularity of such machines with players is dependent on the likelihood (or perceived likelihood) of winning money at the machine and the intrinsic entertainment value of the machine relative to other available gaming options. Where the available gaming options include a number of competing machines and the expectation of winning each machine is roughly the same (or believed to be the same), players are most likely to be attracted to the most entertaining and exciting of the machines.

Consequently, shrewd operators strive to employ the most entertaining and exciting machines available because such machines attract frequent play and, hence, increase profitability to the operator. In the competitive gaming machine industry, there is a continuing need for gaming machine manufacturers to produce new types of games, or enhancements to existing games, which will attract frequent play by enhancing the entertainment value and excitement associated with the game.

One concept that has been successfully employed to enhance the entertainment value of a game is that of a “bonus” game which may be played in conjunction with a “basic” game. The bonus game may comprise any type of game, either similar to or completely different from the basic game, and is entered upon the occurrence of a selected event or outcome of the basic game. Such a bonus game produces a significantly higher level of player excitement than the basic game because it provides a greater expectation of winning than the basic game.

Accordingly, what is needed is a gaming terminal that is capable of providing increased excitement and entertainment value over existing gaming terminals. More specifically, what is needed is a gaming terminal where the cabinet itself is an active feature or element of the wagering game.

In current basic games and bonus games the player is often denied any value from a bonus game if certain predetermined criteria are not achieved. Once the player chooses to stop playing the game in that round, the player is immediately awarded any credits that are remaining and also loses assets that have been accumulated, but not yet awarded. For example, in some games, the bonus game consists of the player collecting assets and when a certain number or combination of assets is accumulated, the player wins an award. However, should the player choose to leave the game prior to winning the award, the player loses all of the assets accumulated. This can cause player frustration and does not provide the player with any incentive to return to the game.

Such a system also encourages “vulturing,” in which the “vulturing” player waits for a person who is close to winning an award to leave the gaming machine prior to the winning of the award. The “vulturing” player then begins to play the machine, and may quickly win the award without investing much time into the game. This is also frustrating for other players.

Thus, there is a need to allow a player to accumulate assets on gaming terminals and to provide some level of payout to the player if they are not able to achieve the highest bonuses available from the terminals. This way, should a player choose to leave a game, the player will receive some payout for the bonuses they have earned. This alleviates the player frustration at losing assets that they have accumulated and also provides the player a more favorable outcome from the wagering, making the player more likely to return to the game at a later date.

### SUMMARY OF THE INVENTION

According to one embodiment of the present invention a gaming terminal for conducting a wagering game comprises a first display, a second display, and a wagering game. The first display displays a plurality of symbols that indicate a randomly selected outcome of the wagering game. The second display displays a bonus game having a plurality of bonus areas. The wagering game has a plurality of symbols that indicate a randomly selected outcome. In response to the randomly selected outcome being a bonus outcome, the wagering game displays a bonus symbol in the second display at a certain location. A bonus is awarded when the bonus symbols are located in at least one of the plurality of bonus areas in the second display.

According to one method of playing a wagering game having a basic game and a bonus game the method conducts the basic game at a gaming terminal. It displays a first set of symbols on a first display of the gaming terminal. The method provides an award based on the outcome of the basic game. It determines a specified condition that a player is required to meet from the display of the first set of symbols to obtain a bonus symbol on a second display of the gaming terminal. The method analyzes the bonus symbols on the second display of the gaming terminal to determine if a winning bonus condition is displayed. The method awards the player a bonus if a winning bonus condition is displayed.

According to another method of playing a wagering game the method conducts a basic wagering game at a gaming terminal. The method displays a first set of symbols on a first display for displaying a plurality of symbols that indicate a randomly selected outcome in response to conducting the basic wagering game. It determines if any of the first set of symbols on the first display satisfy a predefined condition. If at least one of the first set of symbols satisfies a predefined condition, a bonus symbol is displayed on a second display for displaying a bonus game. The method analyzes the second display for a winning combination of bonus symbols at certain locations within bonus areas of the second display. The method awards a bonus in response to analyzing the second display when a winning combination is present.

According to a further method of playing a wagering game having a basic game and a bonus game the method conducts the basic game at a gaming terminal in response to a wager input. The method displays a location for each member of an array of symbols that indicate a randomly selected outcome of the basic game. It displays a bonus game that has a bonus-element receiving region that corresponds to each location of the array of symbols. In response to a bonus-element-adding symbol appearing in the array of symbols of the basic game, the method adds a bonus symbol to the corresponding bonus-element receiving region. In response to the bonus-element receiving regions having a predetermined number of bonus symbols, a bonus award is provided.

The above summary of the present invention is not intended to represent each embodiment or every aspect of the present invention. The detailed description and Figures will describe many of the embodiments and aspects of the present invention.

### BRIEF DESCRIPTION OF THE DRAWINGS

The foregoing and other advantages of the invention will become apparent upon reading the following detailed description and upon reference to the drawings.

FIG. 1 is a front elevational view of a gaming terminal of the present invention.

FIG. 2 is a block diagram of a gaming terminal of the present invention.

FIG. 3 is a flow chart for one embodiment of the wagering game of the present invention.

FIGS. 4-8 are various displays of one embodiment of the wagering game of the present invention.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DESCRIPTION OF ILLUSTRATIVE EMBODIMENTS

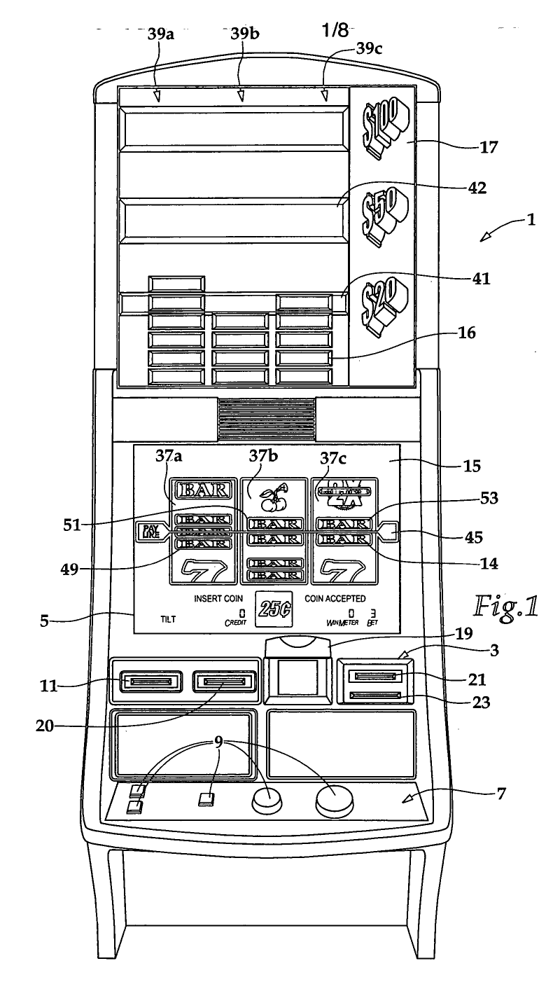

FIG. 1 shows a front elevational view of a typical gaming terminal 1 used by gaming establishments, such as casinos. With regard to the present invention, the gaming terminal 1 may be of any type and may have varying structures and methods of operation. For example, the gaming terminal 1 may be a mechanical gaming terminal configured to play mechanical slots, or it may be an electromechanical or electronic gaming terminal configured to play a video casino game, such as blackjack, slots, keno, poker, etc.

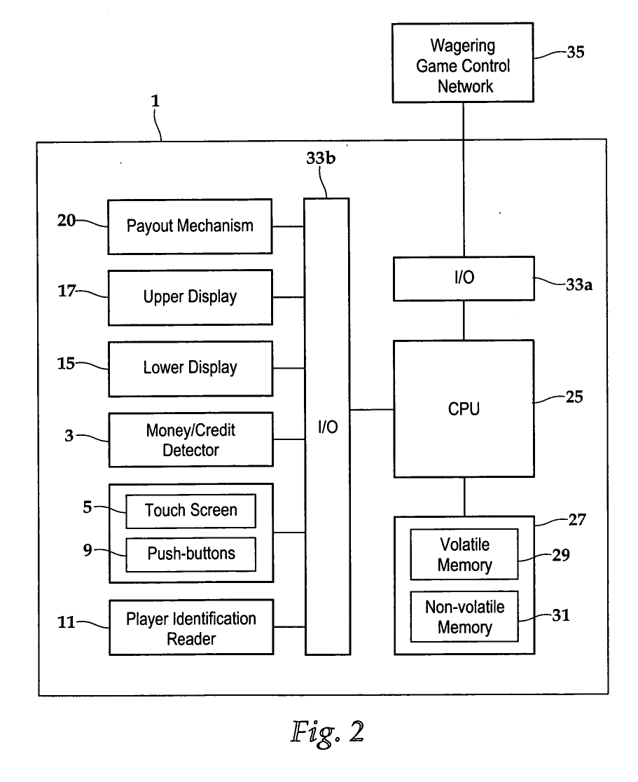

As further shown in FIGS. 1 and 2, the gaming terminal 1 includes input devices, such as a wager acceptor 3, a touch screen 5, a push-button panel 7, including buttons 9, a player-identification card reader 11, and optionally, an arm to pull (not shown). For outputs, the gaming terminal 1 includes a lower display 15 for displaying information about a first game outcome, and an upper display 17 for displaying information about a second game outcome. A payout mechanism 20 also is provided for dispensing receipts to players who have “cashed-out” their remaining credits. The receipt can be taken to a cashier and exchanged for the amount shown on the receipt. In addition or alternatively, the gaming terminal 1 may have payout mechanisms for dispensing coins or notes (not shown) to players who have “cashed-out.”

The gaming terminal 1 also may include a progressive game display (not shown) generally on a top portion of the terminal 1 for displaying the value of a progressive game. The gaming terminal 1 also may include a paytable (not shown) on the face the terminal 1 illustrating the different positive or winning combinations of symbols and the credits awarded when a winning combination is displayed. Alternatively, the paytable may be stored in the computer memory of the gaming terminal 1 and displayed by pushing a button 9 on the push-button panel 7 or touching a specified location on the touch screen 5. While these typical components found in the gaming terminal 1 are described below, it should be understood that numerous other elements may exist and may be used in any number of combinations to create various forms of a gaming terminal.

The wager acceptor 3 may be provided in many forms, individually or in combination. For example, the wager acceptor 3 may accept cash and may include a coin slot acceptor 19 and/or a note acceptor 21 to input value to the gaming terminal 1. In addition, the wager acceptor 3 may include a card-reading device 23 for reading a card that has a recorded monetary value with which it is associated. The card reading device 23 may also receive a card that authorizes access to a central account, which can transfer money to the gaming terminal 1.

The push button panel 7 is typically offered, in addition to the touch screen 5 which overlies the lower display 15 (or a portion thereof), to provide players with an option on how to make their game selections. Alternatively, the push button panel 7 provides inputs for one aspect of operating the game, while the touch screen 5 allows for inputs needed for another aspect of operating the game.

The first game outcome of the wagering game is displayed to the player on the lower display 15 in the form of symbols 14 centered about a payline 45 in one of three reels 37a-c. The lower display 15 may take the form of a cathode ray tube (CRT), a high resolution LCD, a plasma display, LED, or any other type of video display suitable for use in the gaming terminal 1. Alternatively, mechanical reels, well known in the art, may be used to show the first game outcome on the lower display 15.

The second game outcome is displayed to the player on the upper display 17 in the form of upper display symbols 16 displayed in upper display regions 39a-c. The upper display 17 comprises three bonus areas 41-43. The amount of bonus awarded in the three bonus regions may vary from terminal to terminal based on a variety of factors such as the minimum wager allowed on a terminal. The amount of credits awarded by the lowest bonus area 41 is typically less than the amount of credits awarded by the middle bonus area 42. The amount of credits awarded by the top bonus area 43 is more than the amount of credits awarded by either of the lower bonus areas 41, 42.

FIG. 1 depicts a $20 bonus region 41, a $50 bonus region 42, and a $100 bonus region 43. The $20 bonus region 41 has a height equivalent to one upper display symbol 16. The $50 and $100 bonus regions 42, 43, have heights equal to two upper display symbols 16. Similar to the lower display 15, the upper display 17 may take the form of a cathode ray tube (CRT), a high resolution LCD, a plasma display, LED, or any other type of video display suitable for use in the gaming terminal 1. In one embodiment of the present invention, the lower display 15 is a mechanical reel display and the upper display 17 is video display. Alternatively, both the lower display 15 and the upper display 17 may be electronic displays such as video screens.

The player-identification card reader 11 allows for the identification of a player by reading a card with information indicating his or her true identity. It is contemplated that the player-identification device may take on many other forms including a ticket reader, bar code scanner, RFID transceiver or computer readable storage medium interface. Currently, the identification is used by casinos for rewarding certain players with complimentary services or special offers. For example, a player may be enrolled in a gaming establishment's players' club and may be awarded certain complimentary services as that player collects points in his or her player-tracking account. The player inserts his or her card into the player-identification card reader 11, which allows the casino's computers to register that player's wagering at the gaming terminal 1.

As shown in FIG. 2, the various components of the gaming terminal 1 are controlled by a controller or central processing unit (CPU) 25 (such as a microprocessor or microcontroller). To provide the gaming functions, the controller 25 executes one or more game programs stored in a computer readable storage medium, in the form of system memory 27, that allows for the randomly selected first game outcome. The controller 25 performs the random selection (using a random number generator (RNG)) of an outcome from the plurality of possible outcomes of the wagering game. The controller 25 is coupled to or includes the system memory 27. The system memory 27 may comprise a volatile memory 29 (e.g., a random-access memory (RAM)) and a non-volatile memory 31 (e.g., an EEPROM). It should be appreciated that the controller 25 may include one or more microprocessors. Similarly, the system memory 27 may include multiple RAM and multiple program memories.

Communications between the peripheral components of the gaming terminal 1 and the controller 25 occur through input/output (I/O) circuits 33a-b. As such, the controller 25 also controls and receives inputs from the peripheral components of the gaming terminal 1. Further, the controller 25 communicates with external systems via the I/O circuits 33b Although the I/O circuits 33a-b may be shown as a single block, it should be appreciated that the I/O circuits 33a-b may include a number of different types of I/O circuits.

In some embodiments, the controller 25 may not be inside the gaming terminal 1. Instead, the controller 25 may be part of a game network 35 (FIG. 2) and may be used to control numerous gaming terminals 1. In these embodiments, the controller 25 will run the basic games for each of the gaming terminals 1, and may also be used to link the gaming terminals 1 together. The game network 35 can include progressive jackpots that are contributed to by all or some of the gaming terminals 1 in the network.

The gaming terminal 1 often has multiple serial ports, each port dedicated to providing data to a specific host computer system that performs a specific function (e.g., accounting, player-tracking, or a progressive game control system, etc). To set up a typical serial communication hardware link to the host system, the typical RS-232 point-to-point communication protocol that is often present in the gaming terminal 1 is converted to an RS-485 (or RS-485-type) master-slave protocol so as to take advantage of some of the advantages of the RS-485 capability (e.g., multi-drop capability that allows many gaming terminals 1 to communicate with the game control network 35). To perform this function, a custom interface board may be used by the gaming terminal 1 for each communication port in the gaming terminal 1. It should be noted that the gaming terminal 1 can initially be designed to be configured for a typical RS-485 protocol, instead of the typical RS-232 protocol. Further, the gaming terminal 1 may simply be designed for an Ethernet connection.

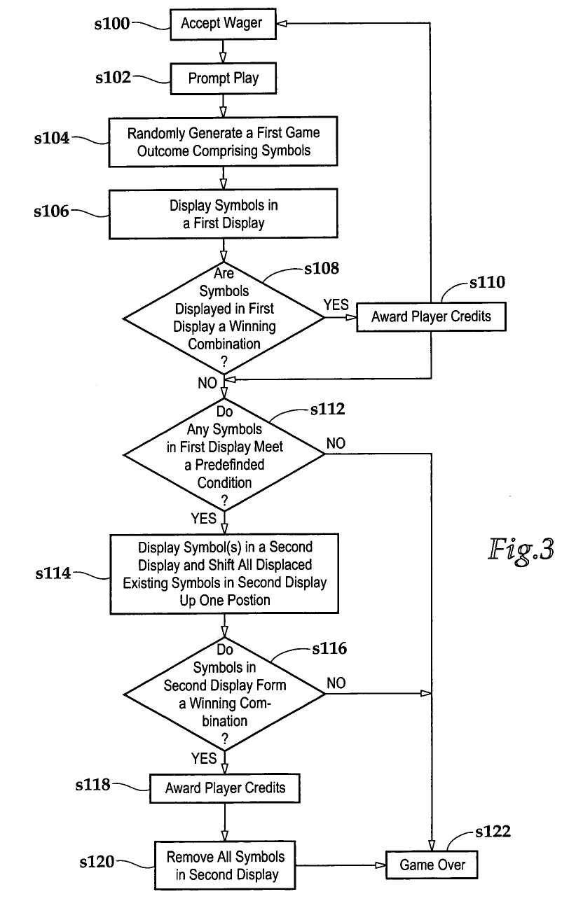

The operation of one embodiment of the wagering game of the present invention now is discussed with respect to FIGS. 1 and 3. Initially, a player inserts a wager at the credit detector 3 of the gaming terminal 1. Once the wager is accepted at S100, the gaming terminal 1 prompts the player to start the game by pushing a button 9 on the button panel 7, pulling down on the arm (not shown), or touching a key on the touch screen 5 at S102. A randomly generated first game outcome is displayed in the form of symbols 14 on the lower display 15 at S104, S106. The symbols 14 are analyzed to determine if a winning combination is formed at S108, and credits are awarded if a winning combination is present on the payline 45 of the lower display 15 at S110. The first game outcome may include symbols that meet a predefined condition. If one or more first game outcome symbols 14 satisfies the predefined condition, then the symbol is added to the upper display 17 at S112, S114. The symbols 16 in the upper display 17 are then analyzed to determine if a winning combination exists.

For example, in one embodiment, if the symbols 14 form a winning combination according to the paytable (not shown), the player is awarded the corresponding number of credits S110, the controller 25 then analyzes whether any of the symbols 14 satisfy a predetermined condition S112. If the symbols 14 shown on the lower display 15 do not form a winning combination, the controller 25 also analyzes whether any of the symbols 14 satisfy a predetermined condition S112. If none of the symbols 14 satisfy the predetermined condition, the game is over unless the player places another wager S122. On the other hand, if one or more of the symbols 14 in the lower display 15 satisfy the predetermined condition, the symbol(s) 16 is added to the upper display 17, S114.

According to the illustrated embodiment of the present invention, the predetermined condition occurs if any of the symbols 14 on the payline 45 of the lower display 15 comprise a bar symbol, such as a three bar symbol 49 or a two bar symbol 51. If a bar symbol is present in the payline 45 of one of the reels 47a-c of the lower display 15, the corresponding number of bar symbols are added to the respective upper display region 39a-c of the upper display 17, S114. As shown in FIG. 1, the payline 45 of the lower display 15 contains a 3-bar symbol 49 in the first reel 37a, a 2-bar symbol 51 in the second reel 37b, and a 2-bar symbol 53 in the third reel 37c. The corresponding number of bars are then added to the upper display 17 as upper display symbols 16 to the corresponding upper display region 39a-c, S114. Thus, in FIG. 1 three upper display symbols 16 will be added to the first upper display region 39a, two upper display symbols 16 will be added to the second upper display region 39b, and two upper display symbols will be added to the third upper display region 39c.

Thereafter, the controller 25 analyzes whether a top most display symbol in each column 39a, 39b, 39c of the upper display 17 are within one of the bonus regions 41, 42, 43 to determine if the player has won a bonus S116. If the top most symbol of each upper display region 39a, 39b, 39c of the upper display 17 are within the same bonus region, the appropriate number of credits are added to the players total S118.

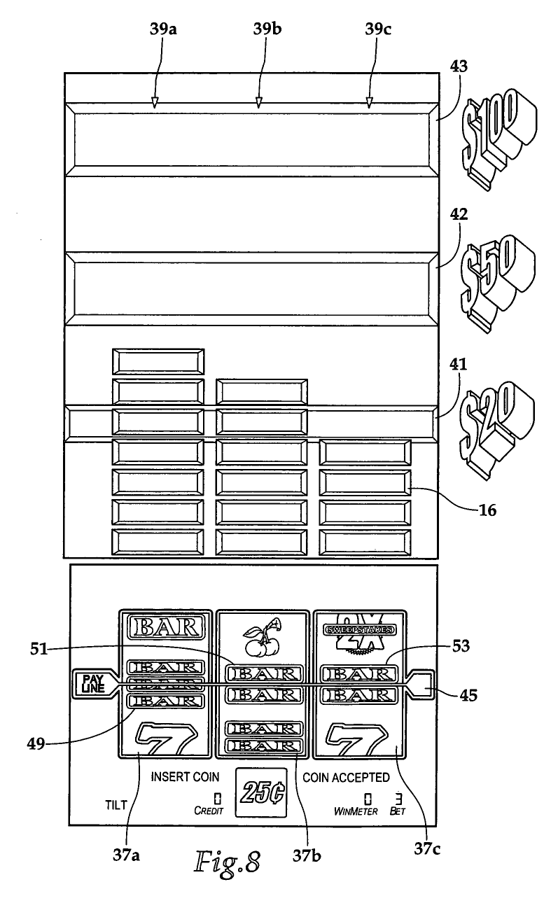

If no winning combination is formed, the game is over unless the player places another wager S120. Alternatively, the player may choose to leave the game and receive an award of credits based on the total number of symbols 16 present in the upper display 17. The award of credits based on the total number of symbols 16 in the upper display is smaller than the bonus paid to the player if the top most symbol 16 of each region 39a-c is within the same bonus region 41,42,43, however, the award of credits based on the total number of symbols 16 in the upper display 17 provides the player with some award to increase customer satisfaction with the wagering experience, and discourages vulturing of the machine by other players. The award of credits based on the total number of symbols 16 in the upper display 17 is further described below in connection with FIG. 8.

Once the player is awarded the credits, either through the bonus or the award of credits based on the total number of symbols in the upper display, the symbols 16 are removed from the upper display 17, S120. The game is then over unless the player places another wager, S122.

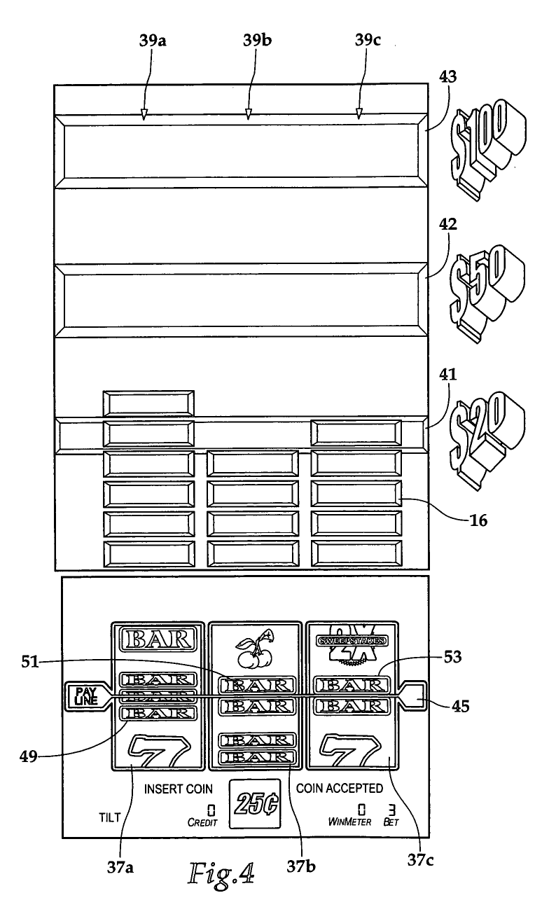

FIG. 4 shows the process by which the player may achieve the bonus on the upper display. The upper display 17 shows a non-bonus winning symbol combination in the upper display regions 39a-c. The top most symbol 16 of display region 39a is above the $20 bonus region 41. The top most symbol 16 of display region 39b is below the $20 bonus region 41. The top most symbol 16 of display region 39c is in the $20 bonus region 41. Thus, since not all of the top most symbols 16 of the upper display regions 39a-c of the upper display 17 are not within the same bonus region 41,42,43, no bonus is awarded. The player is no longer able to receive the $20 bonus, and must now attempt to receive the $50 bonus or the $100 bonus. As previously described in connection with FIG. 1, the $50 bonus area 42 and the $100 bonus area 43 are larger than the $20 bonus area 41. Therefore, the player has a better chance of getting the top most symbol of the upper display regions 39a-c to align within the $50 bonus area 42 or the $100 bonus area 43.

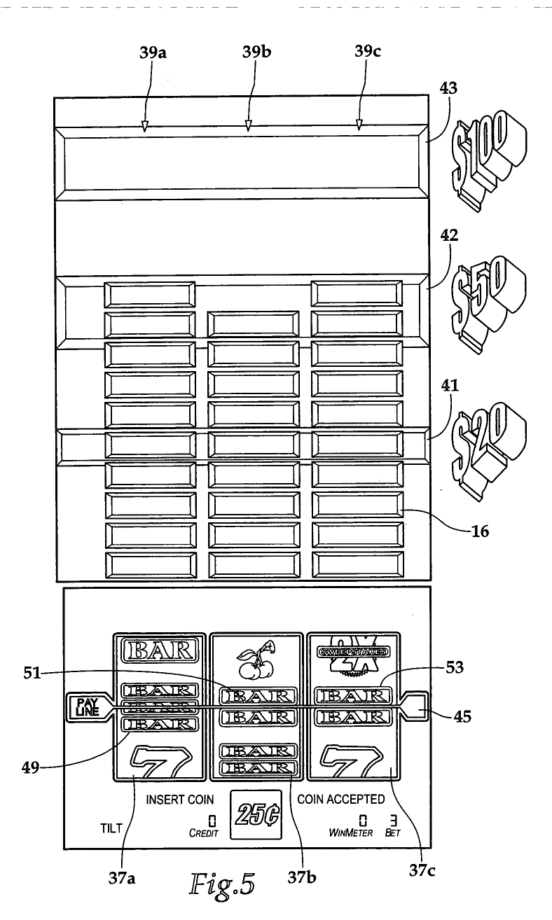

FIG. 5 depicts the lower display 15 and the upper display 17 with the upper display depicting the symbols 16 forming a winning bonus combination. The top most symbols 16 of the upper display regions 39a-c are located within the $50 bonus area 42. Therefore, the player will be awarded $50 worth of credits. After the device credits the player the $50 bonus, all of the upper display symbols 16 will be removed from the upper display 17.

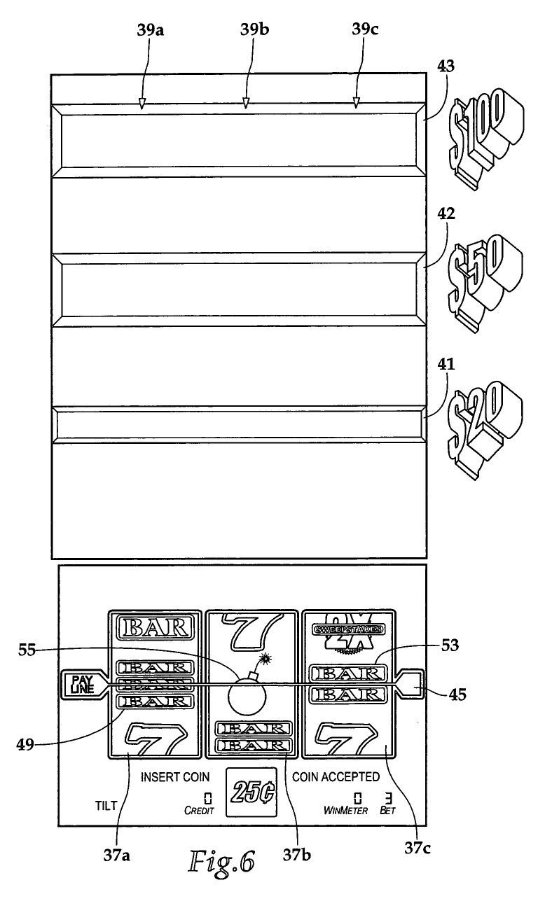

According to one embodiment of the present invention, a “demolition” symbol may be incorporated into the lower display symbols 14. The “demolition” symbol can be used to clear all or some of the upper display symbols 16 symbols shown. on the upper display 17. Turning now to FIG. 6, the lower display 15 contains a “cherry bomb” symbol 55 in the lower reel 37b of the lower display 15. The “cherry bomb” symbol 55 is a destructive symbol according to one embodiment of the present invention. If a “cherry bomb” symbol 55 is on the payline 45 of the lower display 15, all of the upper display symbols 16 are removed from the upper display 17. Therefore, the player must place another wager or the game is ended.

According to an alternate embodiment of the present invention, the demolition symbol will only clear the upper display symbols 16 of the upper display region 39a-c that corresponds to the reel 37a-c where the demolition symbol appeared.

According to another embodiment, a “negative” symbol may be incorporated into the lower display symbols 14. The “negative” symbol removes a single symbol 16 from one or more of regions 39a-c.

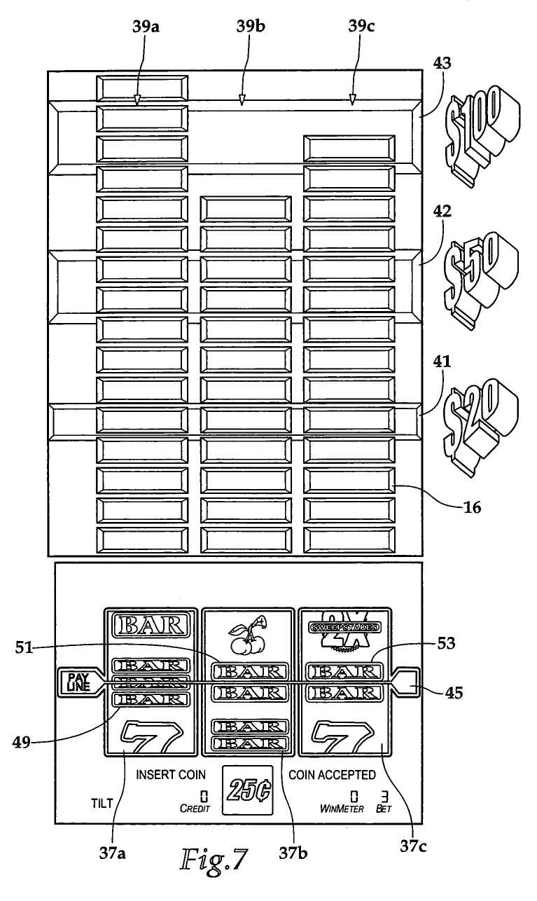

FIG. 7 depicts another result in the basic game that causes the removal of all of the upper display symbols 16 from the upper display 17. The top most upper display symbol 16 of the upper display region 39a is positioned above the $100 bonus area 43. When the top most upper display symbol 16 of any of the upper display regions 39a-c is positioned above the $100 bonus area 43, all of the upper display symbols 16 are removed from the upper display 17. Therefore, the player must place another wager or the game is ended.

According to a further alternate embodiment of the present invention, the removal of symbols from the upper display 17 based on the top most symbol 16 of an upper display region 39a-c exiting the uppermost bonus area 43 will only remove the symbols 16 for that display region 39a, 39b, or 39c, rather than all of the symbols in the upper display 17.

Turning now to FIG. 8, another combination of upper display symbols 16 is depicted on the upper display 17. FIG. 8 depicts a non-winning combination, as the top most symbol 16 of each of the upper display regions 39a-c is not located within the same bonus area 41,42,43. A player may choose to stop wagering on the gaming terminal 1 (FIG. 1) for a variety of reasons. If the player decides to stop wagering, one of the buttons 9 (FIG. 1) of the gaming terminal may be depressed to award the player an award of credits based on the total number of symbols 16 contained in the upper display 17, as previously described in connection with FIG. 3. The award of credits based on the total number of symbols 16 in the upper display will be smaller than the number of credits a player would receive for having the top most symbol 16 of each of the upper display regions 39a-c within the same bonus area 41-43. The award of credits based on the total number of symbols in the upper display will vary based on the number of the upper display symbols 16 contained in the upper display 17. The more symbols 16 displayed, the larger the award of credits based on the total number of symbols in the upper display.

The award of credits based on the total number of symbols 16 in the upper display allows the player to receive some bonus from wagering on the terminal 1, even if the player was never able to have the top most symbol 16 of each of the upper display regions 39a-c aligned within the same bonus area 41-43. This increases the satisfaction of the player by awarding the player some credits for the upper display symbols 16 the player has accumulated. The award of credits based on the total number of symbols 16 in the upper display 17 also discourages vulturing by other players. When a player elects to receive the award of credits based on the total number of upper display symbols 16 in the upper display 17, all of the symbols 16 are cleared from the upper display 17. Therefore, no other player has the opportunity to begin wagering on the terminal 1 and achieve a bonus that was at least partially earned by another player. The elimination of vulturing increases customer satisfaction with the gaming experience as the player will not feel that a second player won a bonus based on the first players wagering.

According to another alternate embodiment of the present invention, the award of credits based on the total number of symbols 16 in the upper display 17 will be random. Thus a first player may not receive the same number of credits as a second player, even if the first and second players have the same number of symbols 16 in the upper display 17.

According to yet a further alternate embodiment of the present invention the award of credits is a non-monetary award, such as sweepstakes entries, invitations to future events, tickets redeemable for merchandise at the gaming location, and other bonus known in the art.

While the present invention has been described with reference to one or more particular embodiments, those skilled in the art will recognize that many changes may be made thereto without departing from the spirit and scope of the present invention. Each of these embodiments and obvious variations thereof is contemplated as falling within the spirit and scope of the claimed invention, which is set forth in the following claims.

What is claimed is:

1. A gaming terminal for conducting a wagering game, comprising:
a first display for displaying a plurality of symbols that indicate a randomly selected outcome of the wagering game; and
a second display for displaying a bonus game and having a plurality of bonus areas;
wherein, in response to the randomly selected outcome being a bonus outcome, the wagering game displays a bonus symbol in the second display at a certain location in the second display and awards a bonus when bonus symbols are located in at least one of the plurality of bonus areas in the second display.

2. The gaming terminal of claim 1, wherein the second display having a plurality of bonus areas has a first bonus area, a second bonus area, and a third bonus area.

3. The gaming terminal of claim 2, wherein the second bonus area bonus is for a value greater than the first bonus area bonus.

4. The gaming terminal of claim 2, wherein the size of the second bonus area and the third bonus area is larger than the first bonus area.

5. The gaming terminal of claim 1, wherein the bonus is a monetary bonus.

6. The gaming terminal of claim 1, wherein the bonus outcome is a bar symbol on a payline of the first display.

7. The gaming terminal of claim 1, wherein the bonus award occurs when bonus symbols for each second display region appear in the same bonus area.

8. A method of playing a wagering game comprising the acts of:
conducting a-basic wagering game at a gaming terminal;
displaying a first set of symbols on a first display for displaying a plurality of symbols that indicate a randomly selected outcome in response to conducting the basic wagering game;
determining if any of the first set of symbols on the first display satisfy a predefined condition;
in response to at least one of the first set of symbols satisfying the predefined condition, displaying a bonus symbol on a second display for displaying a bonus game;
analyzing the second display for a winning combination of bonus symbols at certain locations within bonus areas of the second display; and
awarding a bonus in response to the analyzing the second display when a winning combination is present.

9. The method of claim 8, wherein determining the predefined condition includes determining the number of bar symbols displayed in the first display.

10. The method of claim 8 further comprising the act of providing a player an award based on the bonus symbols on the second display when a winning bonus combination is not displayed.

11. The method of claim 10 further comprising the act of selecting, via player inputs, a monetary award based on the total number of symbols displayed on the second display.

12. The method of claim 10 further comprising the act of selecting, via player inputs, a non-monetary award based on the total number of symbols displayed on the second display.

13. A computer readable storage medium encoded with instructions for directing a gaming machine to perform the method of claim 10.

14. A method of playing a wagering game, the wagering game having a basic game and a bonus game, the method comprising:
conducting the basic game at a gaming terminal in response to a wager input, said conducting including displaying a location for each member of an array of symbols that indicate randomly selected outcome of the basic game;
displaying a bonus game having a bonus-element receiving region that corresponds to each location of the array of symbols;
in response to a bonus-element-adding symbol appearing in the array of symbols of the basic game, adding a bonus symbol to the corresponding bonus-element receiving region; and
in response to the bonus-element receiving regions having a predetermined number of bonus symbols, providing a bonus award.

15. The method of claim 14 further comprising in response to a bonus-element-subtracting symbol appearing in the array of symbols of the basic game, removing a bonus symbol from the corresponding bonus-element receiving region.

16. The method of claim 14, wherein in response to the bonus-element receiving regions having a second predetermined number of bonus symbols, providing a second bonus award that is greater than the bonus award.

17. The method of claim 14, wherein in response to the bonus-element receiving regions not having the predetermined number of bonus symbols, providing a consolation award.

18. The method of claim 14, wherein the displaying a location for each member of an array of symbols that indicate randomly selected outcome of the basic game is on a first display and the displaying a bonus game is on a second display adjacent to the first display.

19. The method of claim 14, wherein the displaying a location for each member of an array of symbols that indicate randomly selected outcome of the basic game is on a reel.

20. A computer readable storage medium encoded with instructions for directing a gaming machine to perform the method of claim 14.
